(19) United States
(12) Patent Application Publication
(10) Pub. No.: US 2011/0198978 A1
(43) Pub. Date: Aug. 18, 2011

(54) TOUCH-SAFE SOLID-STATE LIGHT BULB HAVING ION WIND FAN

(75) Inventors: Brian D. SAWYER, Palo Alto, CA (US); SCOTT L. GOOCH, San Carlos, CA (US)

(73) Assignee: Ventiva, Inc., Santa Clara, CA (US)

(21) Appl. No.: 12/902,836

(22) Filed: Oct. 12, 2010

(51) Int. Cl. H01J 61/52

(52) U.S. Cl. 313/46

(57) ABSTRACT

A solid-state light bulb using an ion wind fan and a heat sink for thermal management can electrically isolate the heat sink to make it touch-safe. In one embodiment, the present invention includes a bulb housing, at least a portion of which is made of a dielectric material and a lens made of a dielectric material, wherein the lens and the bulb together define the inside and outside of the bulb. A heat sink and an ion wind fan providing forced convection for the heat sink thermally manage the solid-state light devices in the bulb. In one embodiment, the outside of the bulb is electrically isolated from the heat sink located inside of the bulb by at least the portion of the bulb housing that is made of the dielectric material.

### RELATED APPLICATIONS

This application is related to U.S. Provisional Patent Application 61/380,175 entitled “Ion Wind Fan in Enclosure,” which is hereby fully incorporated by reference. This application is further related to U.S. patent application Ser. No. 12/782,602 entitled “Solid-State Light Bulb Having an Ion Wind Fan and a Heat Pipe,” which is hereby fully incorporated by reference.

### BACKGROUND

### Field of the Invention

The embodiments of the present invention are related to a lighting device, and in particular to a lighting device containing an ion wind fan.

It is well known that heat can be a problem in many electronics device environments, and that overheating can lead to failure of components such as integrated circuits (e.g. a central processing unit (CPU) of a computer) and other electronic components. Most electronics devices, from LED lighting to computers and entertainment devices, implements some form of thermal management to remove excess heat.

Heat sinks are a common passive tool used for thermal management. Heat sinks use conduction and convection to dissipate heat and thermally manage the heat-producing component. To increase the heat dissipation of a heat sink, a conventional rotary fan or blower fan has been used to move air across the surface of the heat sink, referred to generally as forced convection. Conventional fans have many disadvantages when used in consumer electronics products, such as noise, weight, size, and reliability caused by the failure of moving parts and bearings.

A solid-state fan using ionic wind to move air addresses the disadvantages of conventional fans. However, providing an ion wind fan that meets the requirements of consumer electronics devices presents numerous challenges not addressed by any currently existing ionic wind device. Furthermore, incorporating an ion wind fan into a lighting device, such as an LED light bulb presents further challenges.

### BRIEF DESCRIPTION OF THE DRAWINGS

FIG. 1 is a block diagram illustrating an ion wind fan implemented as part of thermal management of an electronic device;

FIG. 2A is a perspective view of an ion wind fan according to one embodiment of the present invention;

FIG. 2B is a widthwise cross-sectional view of the ion wind fan of FIG. 2A according to one embodiment of the present invention

FIG. 3 is an exploded view of an solid-state light bulb according to one embodiment of the present invention;

FIG. 4 is a top plan view of the light bulb of FIG. 3 according to one embodiment of the present invention;

FIG. 5 is another exploded view of the solid-state light bulb according to another embodiment of the present invention;

FIG. 6 is a perspective view of a heat sink for use in a solid state light bulb according to one embodiment of the present invention;

FIG. 7 is a bottom plan view of the heat sink of FIG. 6 according to one embodiment of the present invention

FIG. 8 is a perspective view of another heat sink for use in a solid state light bulb according to another embodiment of the present invention;

FIG. 9 is a bottom plan view of the heat sink of FIG. 8 according to one embodiment of the present invention;

FIG. 10 is a perspective view of the light bulb of FIG. 3 according to one embodiment of the present invention; and

FIG. 11 is a cross-sectional view of the light bulb of FIG. 10 according to one embodiment of the present invention.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be so limited; rather the principles thereof can be extended to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Ion wind or corona wind generally refers to the gas flow that is established between two electrodes, one sharp and the other blunt, when a high voltage is applied between the electrodes. The air is partially ionized in the region of high electric field near the sharp electrode. The ions that are attracted to the more distant blunt electrode collide with neutral (uncharged) molecules en route to the collector electrode and create a pumping action resulting in air movement. The high voltage sharp electrode is generally referred to as the emitter electrode or corona electrode, and the grounded blunt electrode is generally referred to as the counter electrode, getter electrode, or collector electrode.

The general concept of ion wind—also sometimes referred to as ionic wind and corona wind even though these concepts are not entirely synonymous—has been known for some time. For example, U.S. Pat. No. 4,210,847 to Shannon, et al., dated Jul. 1, 1980, titled “Electric Wind Generator” describes a corona wind device using a needle as the sharp corona electrode and a mesh screen as the blunt collector electrode. The concept of ion wind has been implemented in relatively large-scale air filtration devices, such as the Sharper Image Ionic Breeze.

### Example Ion Wind Fan Thermal Management Solution

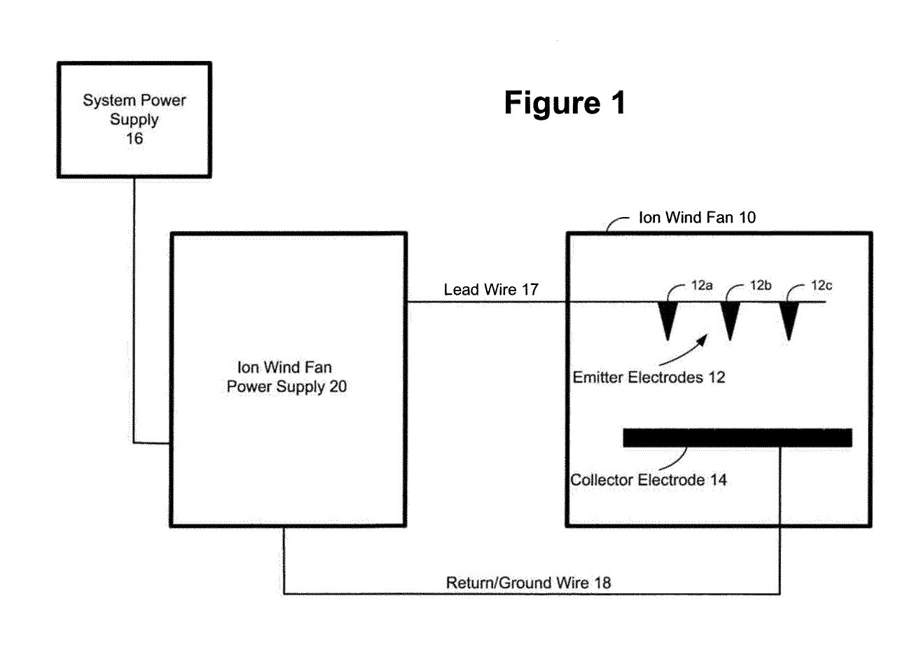

FIG. 1 illustrates an ion wind fan 10 used as part of a thermal management solution for an electronic device. As used in this Application, the descriptive term “ion wind fan,” is used to refer to any electro-aerodynamic pump, electro-hydrodynamic (EHD) pump, EHD thruster, corona wind device, ionic wind device, or any other such device used to move air or other gas. The term “fan” refers to any device that move air or some other gas. The term ion wind fan is meant to distinguish the fan from conventional rotary and blower fans. However, any type of ionic gas movement can be used in an ion wind fan, including, but not limited to corona discharge, dielectric barrier discharge, or any other ion generating technique.

An electronic device may need thermal management for an integrated circuit—such as a chip or a processor—that produces heat, or some other heat source, such as a light emitting diode (LED). Some example systems that can use an ion wind fan for thermal management include computers, laptops, gaming devices, projectors, television sets, set-top boxes, servers, NAS devices, memory devices, LED lighting devices, LED display devices, smart-phones, music players and other mobile devices, and generally any device having a heat source requiring thermal management.

The electronic device can have a system power supply 16 or can receive power directly from the mains AC via a wall outlet, Edison socket, or other outlet type. For example, in the case of a laptop computer, the laptop will have a system power supply such as a battery that provides electric power to the electronic components of the laptop. In the case of a wall-plug device such as a gaming device, television set, or LED lighting solution (lamp or bulb), the system power supply 16 will receive the 110V mains AC (in the U.S.A, 220V in the EU) current from an electrical outlet or socket.

The system power supply 16 for such a plug or screw-in device will also convert the mains AC into the appropriate voltage and type of current needed by the device (e.g., 20-50V DC for an LED lamp). While the system power supply 16 is shown as separate from the IWFPS 20, in some embodiments, one power supply can provide the appropriate voltage to both an ion wind fan 10 and other components of the electronic device. For example, a single driver can be design to drive the LEDs of and LED lamp and an ion wind fan included in the LED lamp.

The electronic device also includes a heat source (not shown), and may also include a passive thermal management element, such as a heat sink (also not shown). To assist in heat transfer, an ion wind fan 10 is provided in the system to help move air across the surface of the heat source or the heat sink, or just to generally circulate air (or some other gas) inside the device. In prior art systems, conventional rotary fans with rotating fan blades have been used for this purpose.

As discussed above, the ion wind fan 10 operates by creating a high electric field around one or more emitter electrodes 12 resulting in the generation of ions, which are then attracted to a collector electrode 14. In FIG. 1, the emitter electrodes 12 are represented as triangles as an illustration that they are generally “sharp” electrodes. However, in a real-world ion wind fan 10, the emitter electrodes 12 can be implemented as wires, shims, blades, pins, and numerous other geometries. Furthermore, while the ion wind fan 10 in FIG. 1 has three emitter electrodes (12a, 12b, 12c), the various embodiments of the present invention described herein can be implemented in conjunction with ion wind fans having any number of emitter electrodes 12.

Similarly, the collector electrode 14 is shown simply as a plate in FIG. 1. However, a real-world collector electrode 14 can have various shapes and will generally include openings to allow the passage of air. The collector electrode 14 can also be implemented as multiple collector electrode members (e.g., rods, washers) held at substantially the same potential. Furthermore, in a real world ion wind fan 10, the emitter electrodes 12 and the collector electrode 14 would be disposed on a dielectric chassis—sometimes referred to as an isolator element—that has also been omitted from FIG. 1 for simplicity and ease of understanding.

To create the high electric field necessary for ion generation, the ion wind fan 10 is connected to an ion wind power supply 20. The ion wind power supply 20 is a high-voltage power supply that can apply a high voltage potential across the emitter electrodes 12 and the collector electrode 14. The ion wind fan power supply 20 (hereinafter sometimes referred to as “IWFPS”) is electrically coupled to and receives electrical power from the system power supply 16. Usually for electronic devices, the system power supply 16 provides low-voltage direct current (DC) power. For example, a laptop computer system power supply would likely output approximately 5-12V DC, while the power supply for an LED light fixture would likely output approximately 20-70V DC.

The high voltage DC generated by the IWFPS 20 is then electrically coupled to the emitter electrodes 12 of the ion wind fan 10 via a lead wire 17. The collector electrode 14 is connected back to the IWFPS 20 via return/ground wire 18, to ground the collector electrode 14 thereby creating a high voltage potential across the emitters 12 and the collector 14 electrodes. The return wire 18 can be connected to a system, local, or absolute high-voltage ground using conventional techniques.

While the system shown in and described with reference to FIG. 1 uses a positive DC voltage to generate ions, ion wind can be created using AC voltage, or by connecting the emitters 12 to the negative terminal of the IWFPS 20 resulting in a “negative” corona wind. Embodiments of the present invention are not limited to positive DC voltage ion wind. Furthermore, while the IWFPS 20 is shown to receive power from a system power supply 30, in other embodiment, the IWFPS 20 can receive power directly from an outlet.

The IWFPS 20 may include other components. Furthermore, in some embodiments, some of the components listed above may be omitted or replaced by similar or equivalent circuits. For example, the IWFPS 20 is described only as an example. Many different kinds and types of power supplies can be used as the IWFPS 20, including power supplies that do not have a transformers or other components shown in FIG. 1. The components described need not be physically separate, and may be combined on a single printed circuit board (PCB).

As described partially above, ion wind is generated by the ion wind fan 10 by applying a high voltage potential across the emitter 12 and collector 14 electrodes. This creates a strong electric field around the emitter electrodes 12, strong enough to ionize the air in the vicinity of the emitter electrodes 12, in effect creating a plasma region. The ions are attracted to collector electrode 12, and as they move in air gap along the electric field lines, the ions bump into neutral air molecules, creating airflow. On a real world collector electrode 14, air passage openings (not shown) allow the airflow to pass through the collector 14 thus creating an ion wind fan.

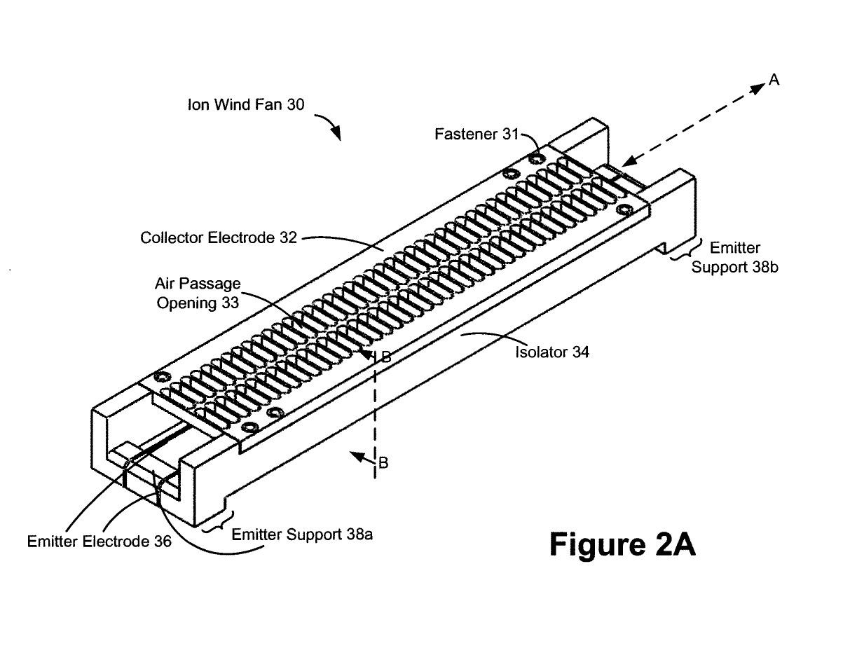

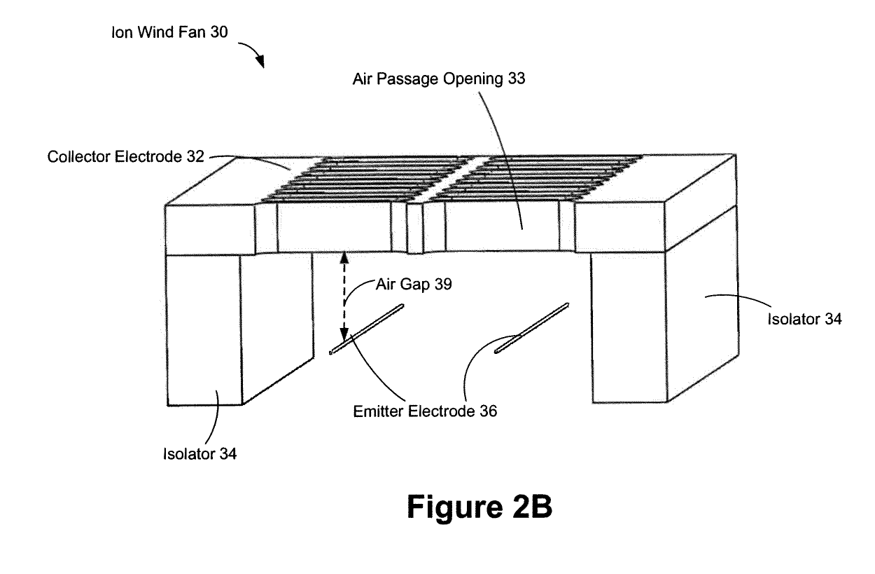

An example of such an ion wind fan is now described with reference to FIGS. 2A and 2B. FIG. 2A is a perspective view of an example ion wind fan 30. The ion wind fan 30 includes a collector electrode 32 having air passage openings 33 to allow airflow. This example ion wind fan 30 has two emitter electrodes 36 implemented as wires, thus implementing what is sometimes referred to as a “wire-to-plane” configuration.

The collector electrode 32 and the emitter electrodes 36 are both supported by an isolator 34. The isolator is made of a dielectric material, such as plastic, ceramic, and the like. The “isolator” component is thusly named as it functions to electrically isolate the emitter electrodes 36 from the collector electrode 32, and to physically support these electrodes. As such the isolator also can establish the spatial relationship between the electrodes, sometimes referred to under the rubric of electrode geometry. The isolator 34 can be made from one integral piece—as shown in FIG. 2A—or it can be made of multiple parts and pieces.

In the embodiment shown in FIG. 2A, the collector electrode is attached to the isolator using a fastener 31. The fastener 31 in FIG. 2 is a stake, but any other attachment method can be used, including but not limited to screws, hooks, glue, and so on. Similarly, the particular method of attachment of the emitter electrodes 36 is not essential to the embodiments of the present invention. The emitter electrodes 36 can be glued, staked, screwed, tied, held by friction, or attached in any other way to the isolator 34.

The ion wind fan 30—in the embodiment shown in FIG. 2A—is substantially rectangular in top view. The longitudinal axis of the ion wind fan 30 is denoted with the dotted arrow labeled “A.” The ion wind fan 30 has two ends opposite each other along the longitudinal axis. The emitter electrodes 36 are suspended between the two ends of the ion wind fan 30.

In one embodiment, the emitter electrodes 36 are supported at the ends of the ion wind fan 30 by an emitter support 38 portion of the isolator 34. The emitter support 38a at the left end of the ion wind fan 30 is most visible in FIG. 2A. The emitter support 38a is a portion of the isolator that physically supports the emitter electrodes 36. In one embodiment, the emitter electrodes 36 are suspended (in tension) between the two emitter supports 38 at the two ends of the ion wind fan 30.

In the embodiment shown in FIG. 2A, the isolator 34 has two elongated members oriented along the longitudinal direction that support the collector electrode 32, and the two elongated members are held joined by two cross-members that support the emitter electrodes 36. In one embodiment, these cross-members are oriented perpendicular to the elongated members (and thus the longitudinal axis). In FIG. 2A, these cross-members make up the emitter supports 38.

Thus, while in one embodiment the emitter support 38a is a substantially rectangular solid portion of the isolator 34 that connects the two elongated side portions of the isolator 34, in other embodiments the emitter supports 38 can have many other shapes and orientations. For example, a part of the center portion of the emitter support 38a between the emitter electrodes 36 could be cut away without substantially affecting the function of the emitter support 38a.

The emitter support 38a is shown as extending to the end of the ion wind fan 30. However, in other embodiments, the emitter support 38a can end before the end of the ion wind fan 30. The emitter support 38a is also shown as having a curved section at its outside edge to smooth out the 90 degree bend in the wire emitter electrodes 36. This is an optional feature not related to the embodiments of the present invention described herein.

Indeed, the actual attachment of the emitter electrodes 36 to either the emitter support 38 or some other portion of the isolator 34 is not material to the embodiments of the present invention, and therefore will not be discussed in much detail for simplicity and ease of understanding. The emitter electrodes 36 are shown as extending downward from the left end of the ion wind fan 30 and they are connected to the power supply via some wire or bus, as is the collector electrode 32. The emitter supports 38 need not have any particular shape of contact with the emitter electrodes 36. The emitter supports 38 are the portions of the isolator 34 that define the physical spatial relationship between the emitter electrodes 34 and other components of the ion wind fan 30. How exactly the emitter supports 38 are in contact with the emitter electrodes 36 (grooves, stakes, friction, posts, welding, epoxy) are not germane to the embodiments of the present invention.

FIG. 2B further illustrates the example ion wind fan 30 shown in FIG. 2A. FIG. 2B is a perspective cross sectional view of the ion wind fan 30 along the line B-B shown in FIG. 2A. The emitter electrodes 36 are suspended in air, and held a substantially constant air gap 39 distance away from the collector electrode 32.

Though wire sag and other emitter irregularities will create some variance, in one embodiment the air gap 39 between the emitter electrodes 36 and the bottom plane of the collector electrode 32 is substantially constant (within a 5% variation). In other embodiments, the air gap 39 can be more variable. The size of the air gap 39 is dependent on the spatial relationship between the electrodes established by the emitter supports 38 (which are not visible in FIG. 2B).

### Touch-Safe Light Bulb

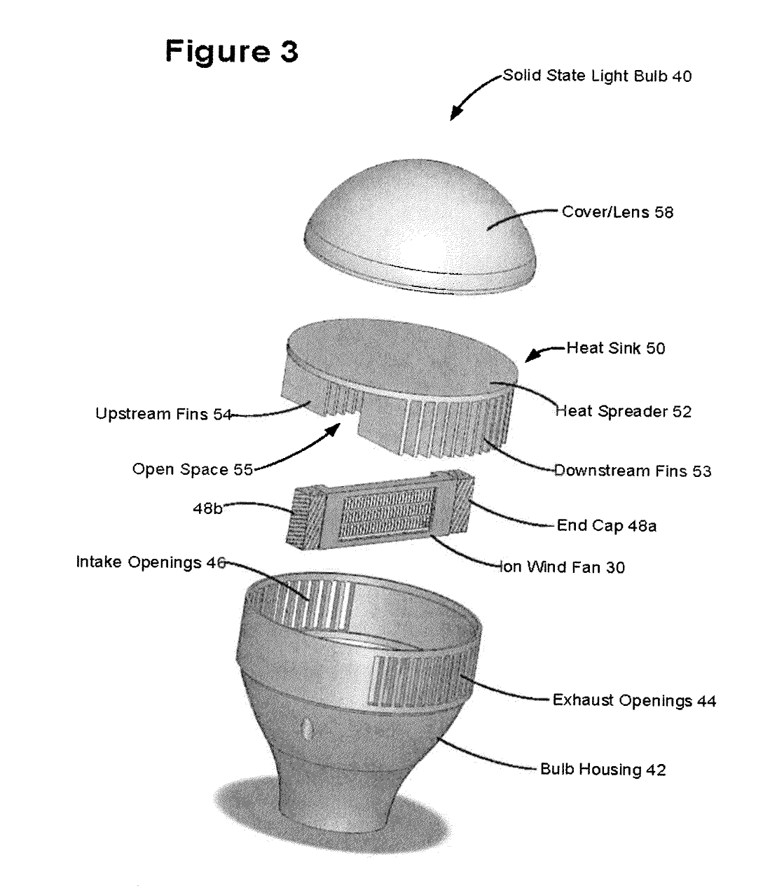

FIG. 3 shows some components of a solid-state (LED) light bulb 40 in an exploded view. Many components—such as a screw-type base/Edison connection or other type of electrical connection, solid-state light sources/LEDs, electronics, and electrical connections—have been omitted for simplicity, ease of understanding, and in order not to obscure the various embodiments of the invention.

The light bulb 40 includes a bulb housing 42. The bulb housing 42 is made of a dielectric material. In one embodiment, this dielectric material is plastic, thermoplastic, ceramic, liquid crystal polymer, or any other known insulator. In one embodiment, the bulb housing 42 is single unitary piece of injection-molded plastic, but it can be assembled from multiple pieces in other embodiments. In other embodiments, only a portion of the bulb housing 42 is made of the dielectric material, as will be described further below.

The bulb housing 42 includes a set of intake openings 46 and a set of exhaust openings that will be described in more detail below. The bulb housing 42 has a hollow cavity to house various electronics components, such as an LED power supply and driver, and the ion wind fan power supply. In one embodiment, this hollow cavity is then electrically isolated with a dielectric cover (not shown).

In one embodiment, an ion wind fan 30 resides inside the widest portion of the bulb housing 42, as shown in FIG. 3, the widest portion having the largest diameter. The ion wind fan 30 is positioned to generate an airflow from the intake openings 46 towards to exhaust openings 44, thereby causing a current of air through the top portion of the bulb housing 42. In the embodiment shown, two dielectric end caps 48 help to secure the ion wind fan 30 against the inside walls of the bulb housing 42.

In one embodiment, the bulb 40 further includes a heat sink 50. As shown in FIG. 3, in one embodiment, the heat sink 50 has a flat, round shaped heat spreader 52 portion. Since the cross-section of this bulb 40 is round, a round shaped heat spreader 52 maximizes the available area for heat dissipation. However, in other embodiment, other shapes, such as square, octagonal, or other such shapes can be used for the heat spreader 52.

In one embodiment, the heat spreader has a surface on which the heat source(s)—the LED devices or other similar solid-state light devices—are mounted, and an opposite surface from which the fins extend. These may sometimes be referred to as the proximate (to the heat source) and distal surface, respectively. In the embodiment shown, the heat spreader 52 has substantially flat proximal and distal surfaces. However, in other embodiments, the proximal surface of the heat spreader 52 may be domed, pyramid-shaped, or having some other contour. The distal surface may also not be flat in other embodiments.

The heat sink 50 also includes one or more sets of fins extending out of the distal surface of the heat spreader 52. In one embodiment, there are two sets of fin, an set of upstream fins 54 and a set of downstream fins 53. In between the two sets of fins there is an opening 55 configured to receive the ion wind fan 30 when the ion wind fan 30 and the heat sink 50 are in position inside the bulb 40. The heat sink 50 can be manufactured as a single cast piece of metal, but other manufacturing techniques can also be used. In yet other embodiments, the heat spreader 52 and the fins 53-4 can be assembled from separate subcomponents (e.g. by welding on each fin).

As set forth above, LEDs—or other solid-state light devices—are mounted on or thermally coupled to the proximal surface of the heat spreader 52. The bulb also includes a cover/lens 58. The cover 58 is transparent or translucent, and may act as a lens or other optics. The cover/lens 58 and the proximal surface of the heat spreader 52 define an optics cavity, where the optical components (such as LED modules) are housed. The bulb housing 42 and the cover 58 define the shape as well as the inside/interior and outside/exterior of the bulb 40.

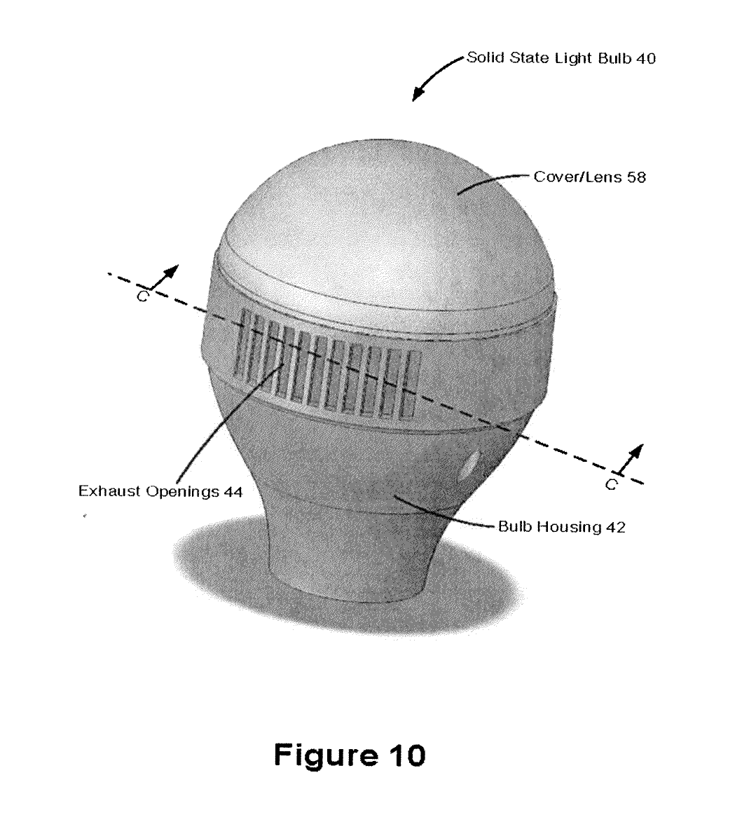

FIG. 10 shows the assembled view of the bulb 40 that is shown in exploded view in FIG. 3. Once again, the base or other electrical connection to mains AC has been omitted for simplicity and ease of understanding. One aspect of this embodiment of the present invention, is that, when assembled (as shown in FIG. 10) the metallic heat sink 50 is not exposed to the outside of the bulb 40. During ordinary handling, a person could touch the cover/lens 58 or the bulb housing 42, but the heat sink 50 is fully contained inside the bulb 40 as defined by the bulb housing 42 and the cover/lens 58.

Referring again to FIG. 3 (and FIG. 10), in one embodiment, the dimensions—including height, width, and depth—of the intake 46 and exhaust 44 openings are such that during normal handling a persons would not contact the metallic heat sink 50 inside the bulb housing 42. For example in one embodiment, the length dimension of the openings 44,46 (the direction parallel with the fins 53-4) is between 10-60 mm, the width dimension of the openings 44,46 (the direction perpendicular with the fins 53-4) is between 3-6 mm, and the depth of the openings 44, 46 is between 1-3 mm.

In other embodiments, the openings 44, 46 can have other shapes, but, in one embodiment, the maximum opening in the minimum opening direction is no more than 6 mm. While it may be possible for a person to reach a pin, pen, or other object through the intake 46 or exhaust 44 openings of the bulb housing 42, during normal handling—such as screwing in or unscrewing the light bulb 40—the user's hands should not touch the heat sink 50.

While the bulb housing 42 has been described as made of a dielectric material with reference to FIG. 3, in other embodiments the bulb housing may include a dielectric portion and a metallic portion joined together. In such embodiments, the portion of the bulb housing 42 that is proximate to the heat sink 50 will be the dielectric portion. In one such embodiment, the intake 46 and exhaust 44 openings are located through the dielectric portion of the bulb housing 42. In another such embodiment, the portions of the bulb housing 42 having the greatest radii are made of the dielectric material, while the portion of the bulb housing 42 that connects to the base (not shown) can be metallic. In one embodiment, where a dielectric separator is used to isolate the ion wind fan 30 from the electronics inside the bulb 40, the portion of the bulb housing between the dielectric separator and the base can be metallic.

One advantage of the embodiment shown in FIG. 3, and other similar embodiments, is that the heat sink 50 can be electrically isolated from the outside of the bulb 40 while still allowing air to flow through the bulb body 42. In one embodiment, the heat sink 50 is electrically floating and thus not connected to the ion wind fan power supply. The metallic heat sink can then conduct charge from the electric field created by the ion wind fan 30.

While most ionic current flows from the emitter to the collectors, some ionic current can flow through the heat sink 50 is it would be connected to ground by the touch of a human user of the bulb while the ion wind fan 30 is operational. Thus, in one embodiment, having the portion of the bulb housing 42 that is proximate to the heat sink be made of a dielectric electrically isolates the heat sink 50 so that the bulb 40 is touch-safe for normal handing, such as screwing and unscrewing the light bulb 40.

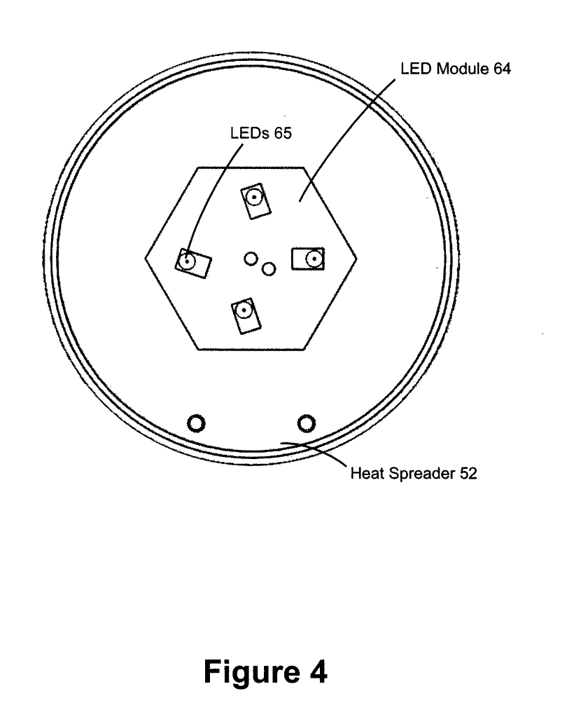

FIG. 4 is a top view of the LED bulb 40 from the top of the cover/lens 58 towards the base (not shown). The cover 58 is also not shown, or alternatively shown as transparent. FIG. 4 shows the proximal surface of the heat spreader and an LED module 64 having four LEDs 65 mounted thereon. In other embodiments, any number of LEDs 65 can be thermally coupled to the heat spreader 52. In one embodiment, the heat spreader 52 has an opening to accommodate electrical connections from the LEDs to the LED driver electronics housed within the bulb housing 42. In other embodiments, other solid-state light sources can be used instead of LEDs without effecting the functionality of the various embodiments of the present invention.

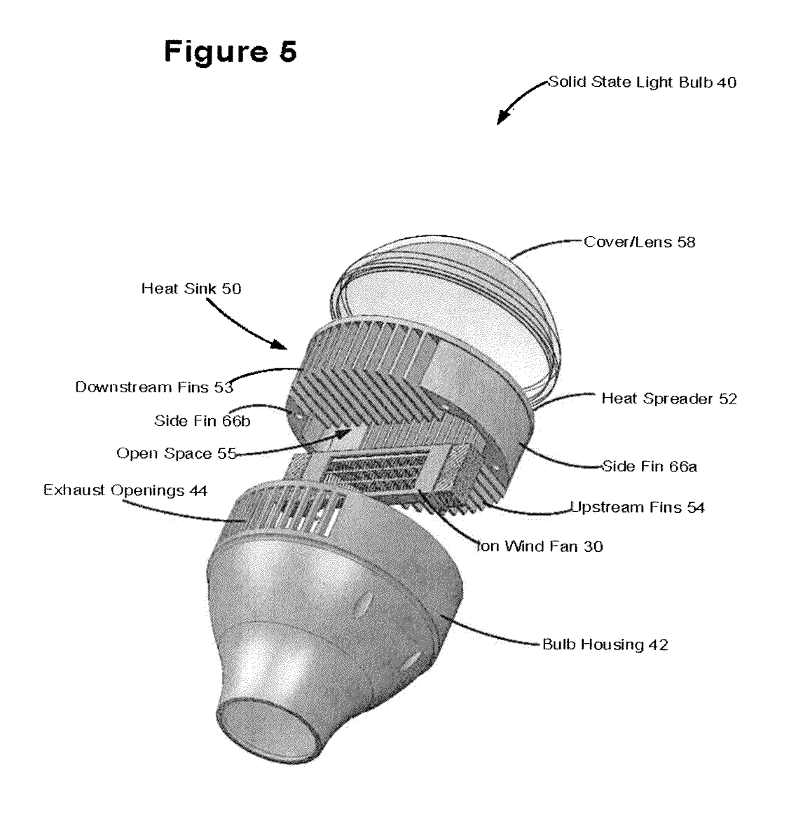

FIG. 5 is another exploded view of the bulb from another perspective. In this view, only the exhaust openings 44 of the bulb housing 42 are visible. This view is from the base towards the cover 58, so that the distal surface of the heat spreader 52 is visible. Also clearly visible are the upstream 54 and downstream 53 fins of the heat sink 50, and the open space 55 between them that receives the ion wind fan 30. One difference is, that the heat sink of the embodiment shown in FIG. 5 also includes side fins 66 that add additional heat dissipation surfaces. The side fins have a rounded surface to be received inside the rounded inner surface of the bulb housing 42.

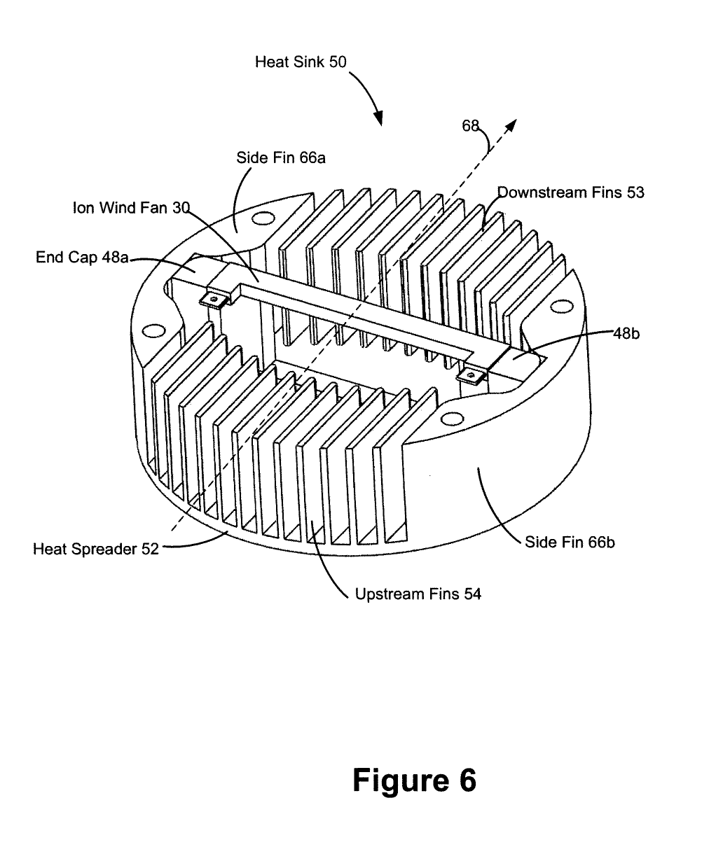

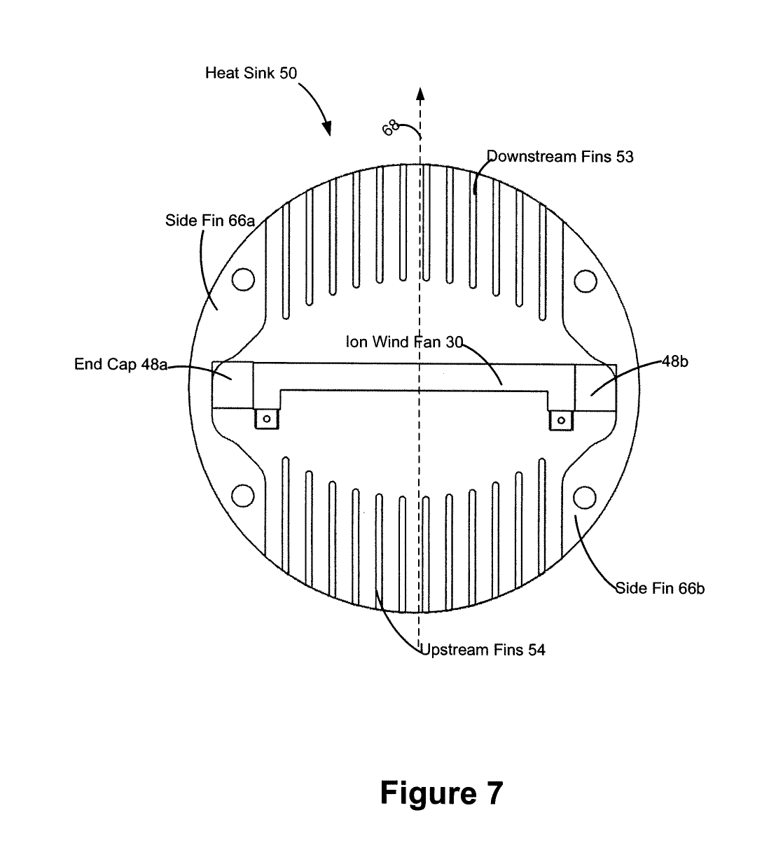

FIG. 6 is a perspective view of one embodiment of the heat sink 50 shown in FIG. 5. The heat sink 50 shown in FIG. 3 can be substantially similar, except the side fins 66 would be omitted. FIG. 7 is yet another view of the heat sink 50 in FIG. 6. The view in FIG. 7 is of the distal surface of the heat spreader 52. In FIGS. 6-7, the direction of the airflow generated by the ion wind fan 30 is indicated by dotted line 68.

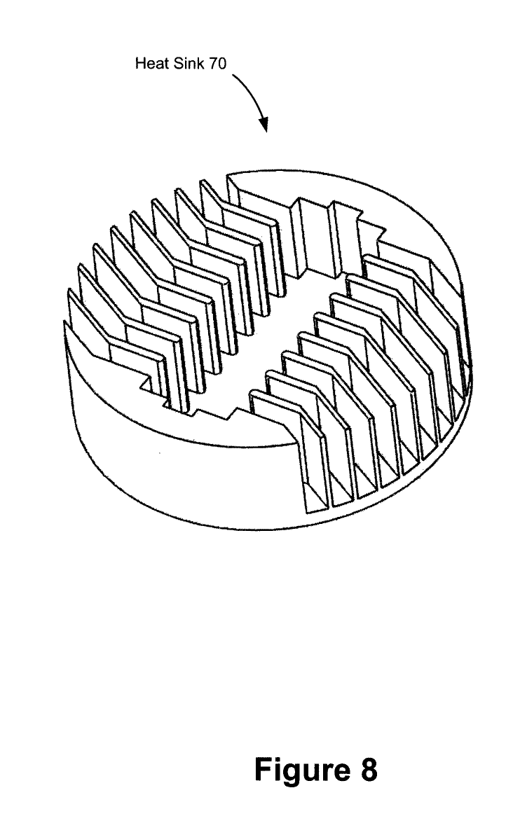

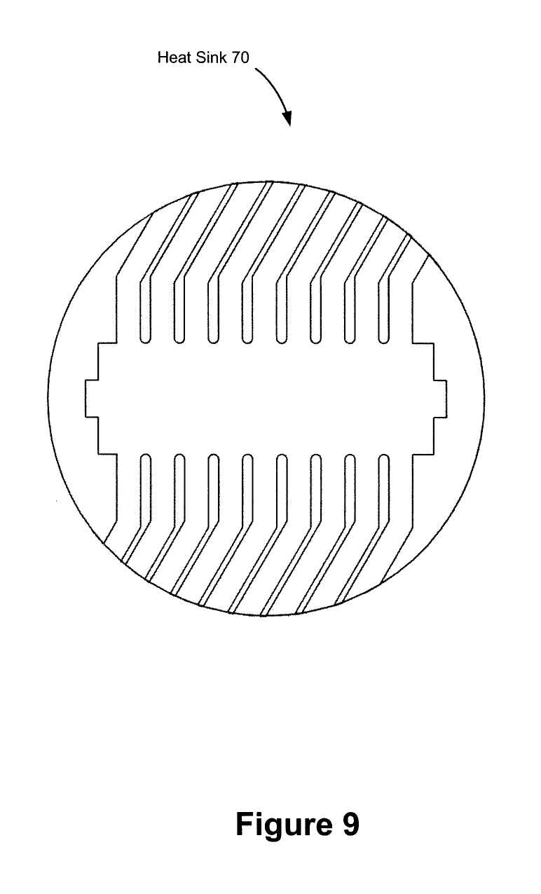

FIGS. 8 and 9 are perspective views of another embodiment for the heat sink 50. Heat sink 70 is similar to heat sink 50, except the fins protruding from the distal surface of the heat spreader are angled to form angled air passage channels. Also, in heat sink 70, the air passage channels are shorted on the sides of the set of fins then in the center, unlike in heat sink 50.

FIG. 10, as stated above, is a perspective view of an embodiment of the light bulb 40 shown exploded in FIG. 3. As can be seen in FIG. 10, the cover/lens 58 portion mates directly with the bulb housing 42. Both the lens 58 and the bulb housing 42 are made of dielectric material. In other embodiments, portions of the bulb housing can be metallic or otherwise contain metal. However, the portion of the bulb housing 42 that is not electrically isolated from the ion wind fan 30 (in other word, the approximately the top portion of the bulb housing that contains the intake 46 and exhaust 44 openings), is made of dielectric material. As an example, in one embodiment, the substantially un-tapered portion of the housing 42 in FIG. 10 could be dielectric, while the tapered portion of the housing 42 could be metallic.

As stated above, in one embodiment, the heat sink 50 is not exposed to the outside of the bulb 40 between the transition of the lens 58 and the bulb body 42. While the heat sink can be contacted through the exhaust openings 44 (or the intake openings 46—not shown in FIG. 10), during normal handling by adult sized hands, even around the intake 46 and exhaust 44 openings, the heat sink 50 will not make contact with the person handling the bulb 40.

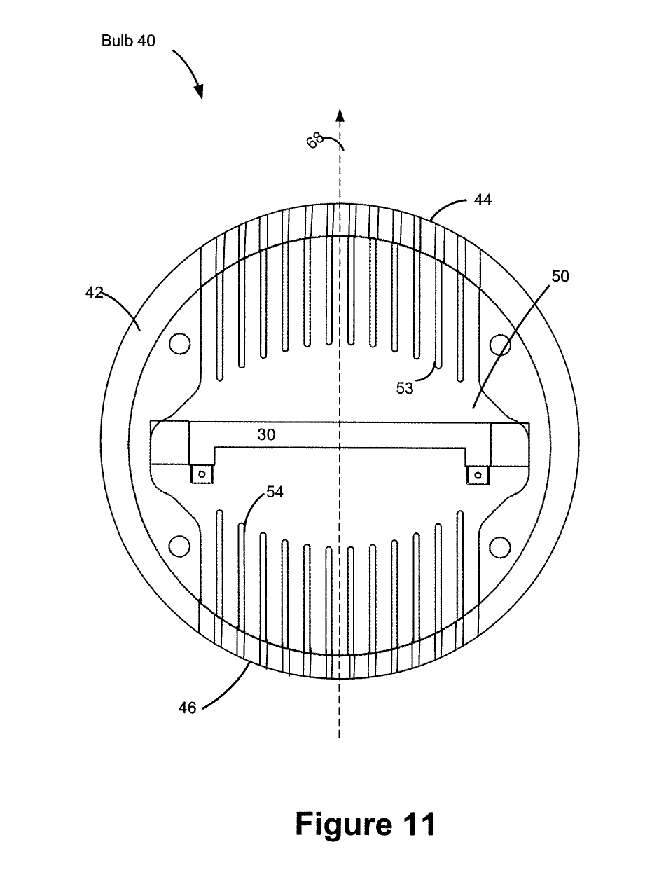

FIG. 11 is a cross-sectional view of a solid-state light bulb 40 (like the bulb in FIG. 10) along the line C-C in FIG. 10. FIG. 11 is not an exact cross-section of FIG. 10, since the bulb in FIG. 11 has two more intake 46 and exhaust 44 opening that the bulb shown in FIG. 10. The heat sink 50 of FIG. 11 is substantially similar to FIG. 7. However, in FIG. 11, the bulb housing 42 (including the intake 46 and exhaust 44 openings) is also visible.

In the embodiments shown in FIG. 11, the intake 46 and exhaust 46 openings of the bulb housing 42 are sized so that they substantially align with the air passage channels between the fins of the heat sink 50. For example, the downstream fins 53 define thirteen air passage channels in FIG. 11. In FIG. 11, there are also thirteen exhaust openings 44 on the bulb body 42. Thus in one embodiment, the exhaust openings 44 extend the air passage channels, so that the walls of the channels are defined by the downstream fins 53 for most of the length of the air passage channels, but are defined by the exhaust openings 44 for the final portion of the air passage channel where air exits the bulb 40. Thus the walls of the channels are metallic in general, but become dielectric at the edge of the bulb 40.

The intake openings 46 forms similar air passage channels with the upstream fins 54, where the initial intake opening is dielectric, but as air moves into the bulb 40 the walls of the air passage channels become metallic. The channels formed in FIG. 11 can be said to be combined channels, formed by the mating of the inlet and exhaust openings with the heat sink channels. The inlet of the combined intake/upstream channel is dielectric for the distance that is the depth of the intake openings while the outlet of the combined exhaust/downstream channel is dielectric for the distance that is the depth of the exhaust openings.

In other embodiments, the openings of the bulb body 42 need not align or mate with the air passage channels of the heat sink 50. For example, the openings of the bulb body 42 may be perpendicular to the shape of the air passage channels defined by the fins heat sink 50. In yet other embodiments, the openings of the bulb body 42 can be round, oval, or any other shape. Similarly, the air passage channels defined by the fins of the heat sink 50 may have shapes other than rectangular as well.

While in the embodiments shown and described above, the LEDs (or other solid-state light devices) are mounted to the heat sink 50, in other embodiments the thermal coupling can be accomplished in other ways. For example, U.S. patent application Ser. No. 12/782,602 entitled “Solid-State Light Bulb Having an Ion Wind Fan and a Heat Pipe,” filed on May 18, 2010 and having the same assignee as the present application describes a solid-state light bulb where the LEDs are coupled to heat sink fins via one or more heat pipes. The fins of such an embodiment can be perpendicular to the fins of heat sink 50 as described above. However, such a heat sink and heat pipe can be electrically isolated using the same or similar techniques and configurations described above. The intake and exhaust openings may change in orientation to mate with the air passage channels, or they may have any other shape where such mating is not implemented.

In the descriptions above, various functional modules are given descriptive names, such as “ion wind fan power supply.” The functionality of these modules can be implemented in software, firmware, hardware, or a combination of the above. None of the specific modules or terms—including “power supply” or “ion wind fan”—imply or describe a physical enclosure or separation of the module or component from other system components.

Furthermore, descriptive names such as “emitter electrode,” “collector electrode,” and “isolator,” are merely descriptive and can be implemented in a variety of ways. For example, the “collector electrode,” can be implemented as one piece of metallic structure (as shown in the FIG. 5C, for example), but it can also be made of multiple members spaced apart, and connected by wires or other electrical connections to the same voltage potential, such as ground.

Similarly, the isolator can be the substantially frame-like component shown in FIG. 2A, but it can have various shapes. The electrodes and the isolator are not limited to any particular material; however, the isolator will generally be made of a dielectric material, such as plastic, ceramic, and other known dielectrics. Thus in one embodiment, any of the collector electrodes discussed herein can be substituted for the collector electrode 32 of FIG. 2A to create an ion wind fan according to an embodiment of the present invention. In other embodiments, other isolator designs can be used, as long as it establishes substantially the same spatial relationships between the electrodes.

1. A solid-state light bulb comprising:
a bulb housing, at least a portion of which is made of a dielectric material;
a lens made of a dielectric material, wherein the lens is coupled to the bulb housing to define an inside of the bulb and an outside of the bulb;
a heat sink comprising a metal located inside of the bulb;
one or more solid-state light devices thermally coupled to the heat sink;
an ion wind fan to provide forced convection for the heat sink;
wherein the outside of the bulb is electrically isolated from the heat sink located inside of the bulb by at least the portion of the bulb housing that is made of the dielectric material.

2. The solid-state light bulb of claim 1, further comprising an ion wind fan power supply, wherein the heat sink is electrically floating with respect to the power supply.

3. The solid-state light bulb of claim 1, wherein the bulb housing is coupled to lens at the portion of the bulb housing that is made of the dielectric material.

4. The solid-state light bulb of claim 1, wherein the bulb housing comprises a plurality of intake openings and a plurality of exhaust openings.

5. The solid-state light bulb of claim 4, wherein the intake and exhaust openings are through the portion of the bulb housing that is made of the dielectric material.

6. The solid-state light bulb of claim 1, further comprising a base coupled to the bulb housing, the base being configured to electrically and mechanically connect the light bulb to a light socket.

7. A solid-state light bulb comprising:
a bulb housing, at least a portion of which is made of a dielectric material, the bulb housing having a set of one or more intake openings and a set of one or more exhaust openings, the intake openings and the exhaust openings being located on the portion of the bulb housing made of the dielectric material;
a heat sink located inside the bulb housing;
one or more solid-state light devices thermally coupled to the heat sink; and
an ion wind fan to generate an airflow from the set of intake openings towards the set of exhaust openings, the airflow providing forced convection for the heat sink;
wherein the set of intake openings and the set of exhaust openings are sized so that a human hand will not contact the heat sink inside the bulb housing during ordinary handling of the light solid-state light bulb.

8. The solid-state light bulb of claim 7, wherein the heat sink comprises an upstream set of fins located upstream from the ion wind fan with respect to the airflow generated by the ion wind fan.

9. The solid-state light bulb of claim 8, wherein the upstream set of fins defines a plurality of upstream air passage channels having an inlet and an outlet, wherein the intake openings have a shape substantially similar to a shape of the upstream air passage channels.

10. The solid-state light bulb of claim 9, wherein the intake opening mate with the upstream air passage channels to form combined air passage channels, each combined air passage channel having a dielectric portion and a metallic portion.

11. The solid-state light bulb of claim 7, wherein the heat sink comprises a downstream set of fins located downstream from the ion wind fan with respect to the airflow generated by the ion wind fan.

12. The solid-state light bulb of claim 11, wherein the downstream set of fins defines a plurality of downstream air passage channels having an inlet and an outlet, wherein the exhaust openings have a shape substantially similar to a shape of the downstream air passage channels.

13. The solid-state light bulb of claim 12, wherein the exhaust opening mate with the downstream air passage channels to form combined air passage channels, each combined air passage channel having a dielectric portion and a metallic portion.

14. The solid-state light bulb of claim 7, wherein the one or more solid-state light devices comprise light-emitting diodes (LEDs).

15. The solid-state light bulb of claim 7, further comprising a base coupled to the bulb housing, the base being configured to electrically and mechanically connect the light bulb to a light socket.

16. The solid-state light bulb of claim 7, wherein the solid-state light devices are thermally coupled to the heat sink via a heat pipe.
